(19) United States
(12) Patent Application Publication
(10) Pub. No.: US 2009/0012968 A1
(43) Pub. Date: Jan. 8, 2009

(54) Medical Image Management System

(76) Inventor: Naoki Hayashi, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/281,745

(22) PCT Filed: Feb. 22, 2007
(86) PCT No.: PCT/JP2007/053270

§ 371 Date: Sep. 4, 2008

(30) Foreign Application Priority Data
Mar. 7, 2006 (JP) 2006-061064

(51) Int. Cl. G06F 17/30; G06K 9/00

(52) U.S. Cl. 707/10; 382/128; 707/E17.004

(57) ABSTRACT

Disclosed a medical image management system including: a plurality of image storing members; a setting member to set configuration information on the produced medical image; an image management information storing member to store image management information; a multi-storing processing member to perform multi-storing of the medical image into the set image storing member at the set multi-storing timing on a basis of the multi-storing destination information and the multi-storing timing information, both set on the medical image; and an image management information supplying member to read the image management information of the medical image from the image management information storing member in response to a requirement of the radiogram interpretation terminal and supplying the read image management information.

### TECHNICAL FIELD

The present invention relates to a medical image management system which stores and manages medical image to supply the medical image to a radiogram interpretation terminal in response to a requirement from the radiogram interpretation terminal.

### BACKGROUND ART

In the medical field, there has been built a medical image management system which stores a medical image generated by a modality which radiographs a subject to generate the medical image, in an image storing member such as a network-attached storage (NAS) connected to the modality through a communication network, and manages the medical image to supply the medical image to a radiogram interpretation terminal in response to a requirement of the radiogram interpretation terminal.

In recent years, hospital-hospital cooperation, i.e., cooperation between hospitals, and hospital-clinic cooperation, i.e., cooperation between a hospital and a clinic, have been progressing, and the medical images of a plurality of different departments in a medical facility and the medical images of each department in different medical facilities have been begun to be stored by the use of a plurality of NASs.

Regarding a system using such a plurality of NASs, for example, Patent Document 1 describes a backup obtaining apparatus that obtains the backups of one or more NASs to manage the data of the NASs.

Patent Document 1: Japanese Patent Application Laid-Open Publication No. 2003-296169

### DISCLOSURE OF THE INVENTION

### Problem to be Solved by the Invention

Now, it sometimes becomes necessary to perform multi-storing of one medical image into a plurality of NASs doubly or trebly if the medical images in a plurality of different departments of one medical facility and the medical images of each department of different medical facilities are stored. For example, a case can be cited where an accessible NAS is provided to each of the medical facilities and produced medical images are stored in a plurality of NASs corresponding to the related medical facilities.

However, if the medical images produced by the modality are instantaneously written into a plurality of NASs so as to be multi-stored, then the loads of a server writing the medical images into the NASs and of a communication network are large. Consequently, disadvantages such as the difficulty of the writing of a medical image to be newly written are sometimes caused.

Moreover, if one of the NASs is determined as an object in which a certain medical image is written, then there is the case where the medical image cannot be instantaneously written into the previously determined NAS when the object NAS is out of order or the access to the NAS is jammed. In such a case, the writing of the medical image can be performed into another NAS so as to be stored therein. But, a problem is caused in which a user cannot know which NAS the medical image has been written in when the user wants to access the medical image from a radiogram interpretation terminal.

Moreover, because the data using method of each medical image differs from each other according to the kind of the data of a medical image, the level of a facility and of the person in charge which use the medical image, and the like, the immediacy and the necessity of multi-storing are also different from each other. If multi-storing of all of the medical images is performed to all of the NASs equally, capacitative waste is caused.

On the other hand, if the NASs in which multi-storing of a medical image is performed and the NASs in which multi-storing of the medical image is not performed exist to each medical image, or if the timing of multi-storing varies to each NAS, then a problem is caused in which it cannot be known which NAS includes the medical image when a radiogram interpretation terminal wants to access the medical image.

It is an object of the present invention, in the medical image management system, to enable multi-storing of a medical image only to a necessary image storing member at as-needed timing, and to enable confirming the multi-storing situation of a medical image from the radiogram interpretation terminal.

### Means for Solving the Problem

According to a first aspect of the present invention, a medical image management system to manage a medical image produced by an image producing member to radiograph a subject to produce the medical image, and to supply the medical image in response to a requirement from a radiogram interpretation terminal equipped with a display member, the system including:

a plurality of image storing members to store the produced medical image;

a setting member to set configuration information on the produced medical image, the configuration information including storing destination information specifying an image storing member to be a storing destination of the medical image, multi-storing destination information specifying an image storing member to be a multi-storing destination of the medical image, and multi-storing timing information indicating multi-storing timing of the medical image to the image storing member to be the multi-storing destination;

an image management information storing member to store image management information, the image management information being information for managing the medical image and including the configuration information set by the setting member;

a writing member to write the produced medical image into at least one of the plurality of image storing members on a basis of the storing destination information set on the medical image;

a multi-storing processing member to perform multi-storing of the medical image into the set image storing member at the set multi-storing timing on a basis of the multi-storing destination information and the multi-storing timing information, both set on the medical image; and

an image management information supplying member to read the image management information of the medical image from the image management information storing member in response to a requirement of the radiogram interpretation terminal and supplying the read image management information.

Preferably, the multi-storing processing member registers multi-storing result information indicating whether multi-storing has been completed or not into the image management information storing member.

Preferably, the writing member writes the medical image into another image storing member and registers storing result information into the image management information storing member when it is impossible to write the medical image into an image storing member corresponding to the storing destination information set on the medical image.

Preferably, the writing member adds information about the image storing member corresponding to the storing destination information set on the medical image and predetermined multi-storing timing information to the multi-storing destination information set on the medical image when it is impossible to write the medical image into the image storing member corresponding to the storing destination information set on the medical image.

Preferably, the setting member is capable of setting access limiting information for limiting access to the medical image in the image storing member to be the storing destination or the multi-storing destination of the medical image;

the image management information storing member stores image management information including the access limiting information for limiting the access to the medical image in the image storing member to be the storing destination or the multi-storing destination of the medical image; and

the image management information supplying member supplies the image management information including the access limiting information to the radiogram interpretation terminal.

### EFFECT OF THE INVENTION

According to the first aspect of the present invention, it becomes possible to perform multi-storing of the medical image produced by the image producing member only to the necessary image storing member at as-needed timing, and also it becomes possible to confirm the multi-storing situation of the medical image from the radiogram interpretation terminal.

Moreover, it becomes possible to confirm whether multi-storing has been completed or not from the radiogram interpretation terminal.

Moreover, even if it is impossible to write the medical image produced by the image producing member into the image storing member to be the storing destination of the medical image, the medical image management system writes the medical image into the other image storing member and registers that effect into the image management information. Consequently, no delay of processing is caused, and the using problem in which the storing destination of the medical image becomes unknown is not caused to enable the storing of the medical image.

Moreover, if it has been impossible to write the medical image produced by the image producing member into the image storing member to be the storing destination of the medical image, the medical image management system adds the information about the image storing member the writing of the medical image to which has not been able to the multi-storing destination information set on the medical image. Consequently, it becomes possible to save the medical image into the image storing member to be the storing destination by multi-storing more surely.

Moreover, it is also becomes possible to apply the access limitation individually to the medical image stored in the image storing member, and to confirm the access limiting information from the radiogram interpretation terminal.

### BRIEF DESCRIPTION OF THE DRAWINGS

FIG. 1 is a diagram showing the whole configuration of a medical image management system according to the present invention;

FIG. 2 is a block diagram showing the functional configuration of a write server of FIG. 1;

FIG. 3 is a block diagram showing the functional configuration of a multiplex server of FIG. 1;

FIG. 4 is a diagram showing a data configuration example of an image management information file to be stored in a database of FIG. 1;

FIG. 5 is a block diagram showing the functional configuration of a radiogram interpretation terminal of FIG. 1;

FIG. 6 is a diagram showing an outline of processing between each apparatus of the medical image management system of FIG. 1;

FIG. 7 is a diagram showing image writing processing to be executed in the write server of FIG. 1 and image writing sequences to be executed in the write server, the database, and NASs in response to the image writing processing;

FIG. 8 is a diagram showing multi-storing processing to be executed by the multiplex server of FIG. 1 and multi-storing processing sequences to be executed in the multiplex server, the database, and NASs in response to the multi-storing processing; and

FIG. 9 is a diagram showing access destination confirming processing to be executed in the radiogram interpretation terminal of FIG. 1 and access destination confirming processing sequences to be executed in the radiogram interpretation terminal and the database.

### BEST MODE FOR CARRYING OUT THE INVENTION

In the following, an embodiment of the present invention will be described in detail with reference to the attached drawings. However, the scope of the present invention is not limited to the shown examples.

First, the configuration of the present embodiment is described.

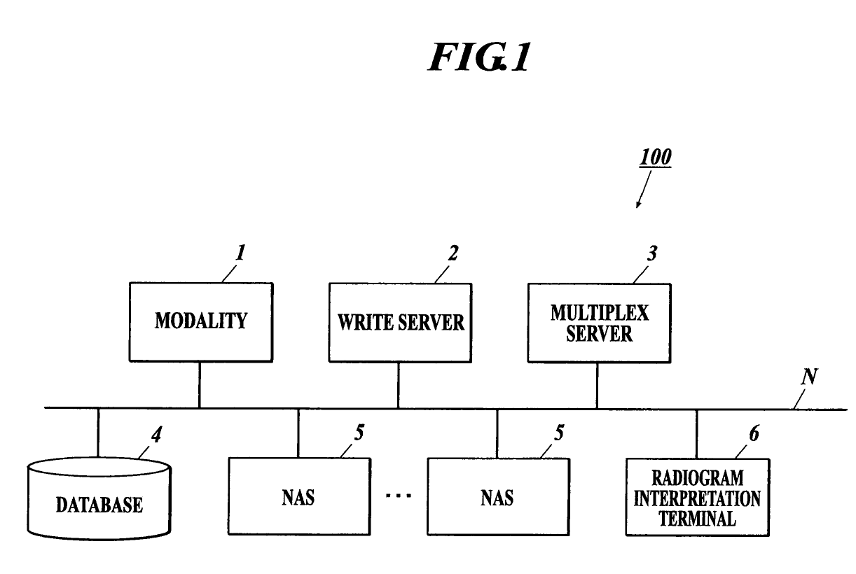

FIG. 1 is a conceptual diagram showing the system configuration of a medical image management system 100 of the present embodiment. As shown in FIG. 1, in the medical image management system 100, a modality 1, a write server 2, a multiplex server 3, a database 4, a plurality of network attached storages (NASs) 5, and a radiogram interpretation terminal 6 are connected so as to be able to perform data transmission and reception through a communication network N composed of a communication line, such as a local area network (LAN) and a wide area network (WAN). The digital image and communications in medicine (DICOM) standard is generally used as a communication system in a hospital, and DICOM modality worklist management (MWV) and DICOM modality performed procedure step (MPPS) are used in the communications between each apparatus on the communication network N mentioned above. Incidentally, the numbers of the modality 1, the NASs 5, and the radiogram interpretation terminal 6 are not especially limited. If each apparatus is severally composed of a plurality of apparatus, identification information for identifying each of them individually is given to each, and it is made to be able to identify each apparatus in the medical image management system 100. For example, identification information for identifying each of the NASs 5 is given to each of the NASs 5, and consequently each of the NASs 5 can be identified in the medical image management system 100.

The modality 1 is, for example, a computed radiography (CR), a flat panel detector (FPD), a computed tomography (CT), a magnetic resonance imaging (MRI), or ultrasonic diagnostic equipment, and performs the digital conversion of an image obtained by radiographing a human body to produce image data of a medical image. Moreover, the modality 1 is equipped with an input member, such as a keyboard, a mouse, and a touch panel, and writes the accompanying information pertaining to a medical image input with a not-shown reception terminal of an examination reservation and an input member, such as the keyboard, the mouse, and the touch panel, into the header portion of image data to transmit the image data to the write server 2.

The accompanying information includes, for example, patient information pertaining to a patient, such as patient ID as the identification information of the radiographed patient, the full name, the age, and the distinction of sex, of the patient; examination information pertaining to an examination, such as examination ID for identifying the examination, a radiographing date, a radiographing region, and radiographing conditions (such as the radiographing region and a radiographing direction); and image data information, such as image ID for identifying an image, and image file name.

Moreover, the modality 1 is configured so as to be able to set configuration information by the input member to each piece of image data produced, which configuration information includes the identification information (storing destination information) of a NAS 5 to be a first storing destination of the image data, the identification information (multi-storing destination information) of the NASs 5 to be multi-storing destinations, the multi-storing timing information (such as a date and a time) of the image data to each of the NASs 5 to be the multi-storing destinations, and access limiting information of the image data in each of the NASs 5 (the information of a user, a facility, and the like, which are capable of accessing the image data stored in each of the NASs 5). The modality 1 accompanies the image data with the accompanying information including the configuration information set by the input member as a setting member, and transmits the accompanying information to the write server 2.

The write server 2 writes the image data of a medical image produced by the modality 1 into the NAS 5 specified by the storing destination information included in the accompanying information of the image data, and registers the storing destination path information of the NAS 5 into the database 4 after the completion of the storing of the image data. Moreover, the write server 2 registers the accompanying information including the multi-storing destination information and the multi-storing timing information of medical image data into the database 4.

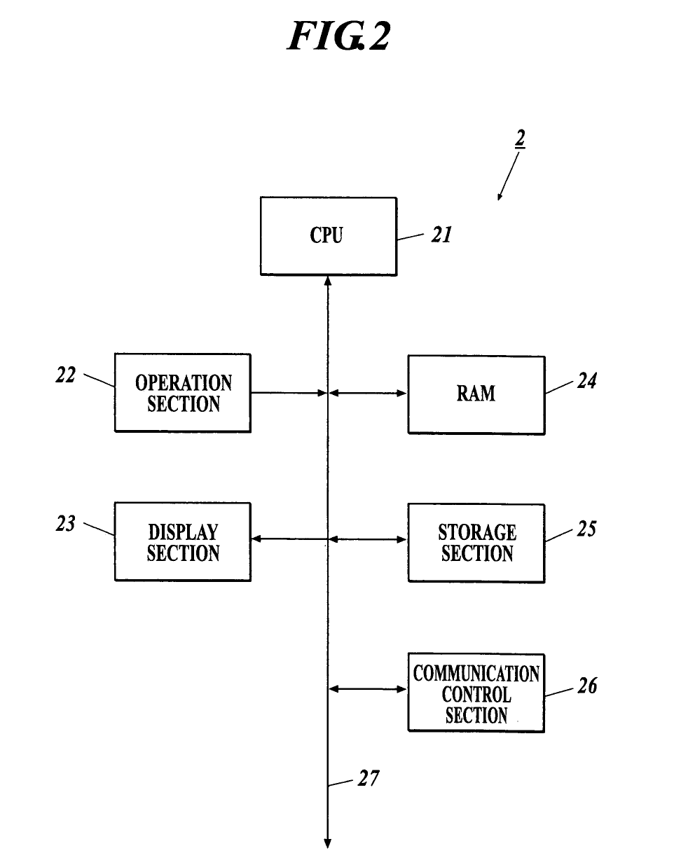

In the following, the internal configuration of the write server 2 will be described in detail with reference to FIG. 2.

FIG. 2 is a block diagram showing the functional configuration of the write server 2. As shown in FIG. 2, the write server 2 is composed of a CPU 21, an operation section 22, a display section 23, a RAM 24, a storage section 25, a communication control section 26, and the like, and each section is connected to one another through a bus 27.

The central processing unit (CPU) 21 reads a system program stored in the storage section 25, and develops the read system program in the work area formed in the RAM 24 to control each section in accordance with the system program. Moreover, the CPU 21 reads various processing programs including an image writing processing program, which are stored in the storage section 25, and develops the read processing programs into the work area formed in the RAM 24 to execute various kinds of processing including image writing processing, which will be described later.

The operation section 22 is composed of a keyboard equipped with cursor keys, numeral inputting keys, and various function keys; and a pointing device, such as a mouse. The operation section 22 outputs an instruction signal input by a key operation to the keyboard or a mouse operation to the CPU 21. Moreover, the operation section 22 may be provided with a touch panel on the display screen of the display section 23, and outputs an instruction signal input with the touch panel to the CPU 21 in this case.

The display section 23 is composed of a monitor, such as a liquid crystal display (LCD) and a cathode ray tube (CRT), and displays an input instruction from the operation section 22, data, and the like, in accordance with an instruction of a display signal input from the CPU 21.

The random access memory (RAM) 24 forms a storage region for temporarily storing various programs executable in the CPU 21, which programs are read from the storage section 25, input data, output data, parameters, and the like, in various kinds of processing the execution of which is controlled by the CPU 21.

The storage section 25 is composed of a nonvolatile semiconductor memory, such as a hard disc drive (HDD), and stores the system program executed in the CPU 21, various processing programs including the image writing processing program corresponding to the system program, various data, and the like. These various programs are stored in the form of readable program codes, and the CPU 21 executes the operations in accordance with the program codes sequentially.

The communication control section 26 is equipped with a LAN adapter, a router, a terminal adapter (TA), and the like, and performs the transmission and the reception of data with each apparatus connected to the communication network N.

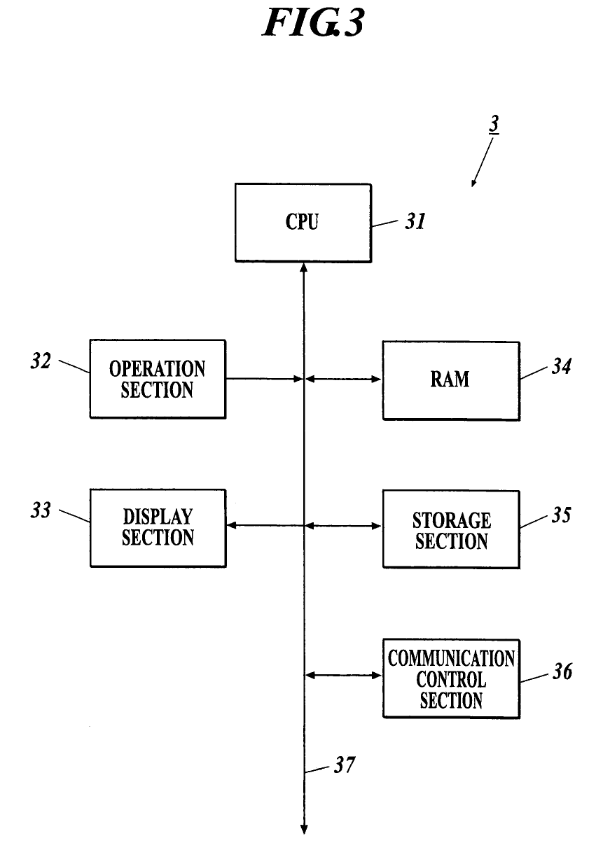

The multiplex server 3 of FIG. 1 is composed of a CPU 31, an operation section 32, a display section 33, a RAM 34, a storage section 35, a communication control section 36, and the like, and each section is connected to one another through a bus 37, as shown in FIG. 3. The CPU 31 of the multiplex server 3 executes the multi-storing processing, which will be described later, by the software processing by the cooperation with the multi-storing processing program stored in the storage section 35 every predetermined time to inquire of the database 4 about whether there is image data to which multi-storing timing has come or not. If the image data to which multi-storing timing has come exists, the CPU 31 obtains the storing destination path information and the multi-storing destination information of the image data, and reads the image data through the storing destination path of the NAS storing the image data to write the read image data into the NAS 5 specified by the multi-storing destination information (performance of multi-storing). Then, the CPU 31 registers the multi-storing result into the database 4.

The database 4 is an image management information storing member to store the image management information of medical image, and is composed of a CPU, a communication control section, a storage section storing a data managing program, a HDD storing an image management information file 41, and the like, all of which are not shown. The database 4 writes the information the registration of which is instructed from an external apparatus (such as the write server 2, the multiplex server 3, the radiogram interpretation terminal 6, or the like) connected to the database 4 through the communication network N into the corresponding item in the image management information file 41 by the software processing by the cooperation of the CPU and the data managing program. The database 4 retrieves the image management information file 41 as an image management information supplying member in response to a requirement from the external apparatus, and reads the information according to the requirement to transmit (supply) the read information to the external apparatus of the transmission source. Incidentally, the storage medium to store the image management information file 41 is not limited to the HDD, but other storage media may be used.

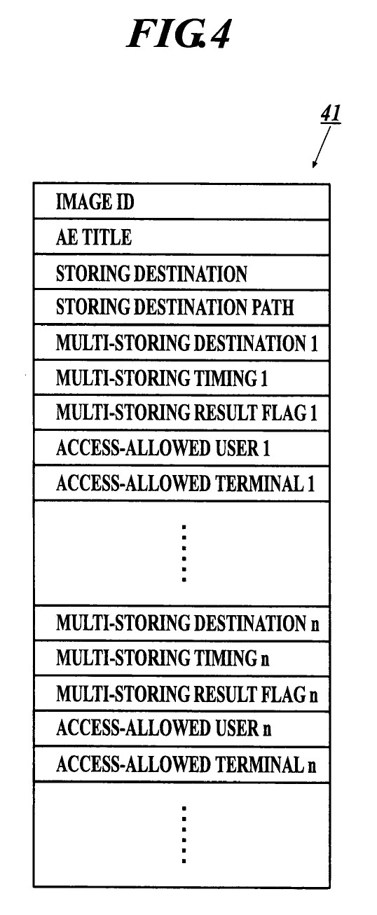

FIG. 4 shows a data configuration example of the image management information file 41 to be stored in the database 4. As shown in FIG. 4, the image management information file 41 is a database file to store the image management information for managing each piece of image data produced by the modality 1. The image management information file 41 includes an “image ID” item for storing image ID for identifying image data as a main key, an “AE title” item for storing an “AE title” item (the communicating identification information of each modality 1 in the DICOM standard) of the modality 1 that produced the image data, a “storing destination” item (for example, the identification information of the NAS 5) for storing the storing destination information of the image data set by the setting member, a “storing destination path” item for storing the storing destination path information (storing result information) of the storing destination path through which the writing of the image data has been actually performed, “multi-storing destination 1” to “multi-storing destination n (n is an integer of two or more)” items for storing the multi-storing destination information (the identification information of the NASs 5 here) of the image data set by the setting member, “multi-storing timing 1” to “multi-storing timing n” items for storing multi-storing timing information (for example, a date and time information) indicating the timing when the image data is written in each of the “multi-storing destination 1” to “multi-storing destination n” items set by the setting member, “multi-storing result flag 1” to “multi-storing result flag n” items for storing flags indicating whether the image data has been multi-stored in each of the multi-storing destinations corresponding to the “multi-storing destination 1” to the “multi-storing destination n” or not (for example, if the image data has not been multi-stored (the case of being uncompleted), then “0,” and if the image data has been multi-stored (the case of being completed), then “1”), “access-allowed user 1” to “access-allowed user n” items for storing the identification information of users accessible to the image data multi-stored in the “multi-storing destination 1” to “multi-storing destination n” items set by the setting member, “access-allowed terminal 1” to “access-allowed terminal n” items for storing the identification information of the terminals (radiogram interpretation terminal 6 and the like) accessible to the image data multi-stored in the “multi-storing destination 1” to “multi-storing destination n” items, and the like. Incidentally, the pieces of data denoted by the same number in each item correspond to one another.

The NASs 5 are image storing members to store the image data of a medical image. Each of the NASs 5 is composed of a CPU, a communication control section, a storage section storing an image data managing program, a HDD, and the like, all of which are not shown. The NASs 5 write the image data the writing of which has been instructed by the write server 2 or the multiplex server 3 into the HDD by the software processing by the cooperation of the CPU and the image data managing program. Moreover, the NASs 5 read imaged data according to an image obtainment requirement from the multiplex server 3 to transmit the read image data to the multiplex server 3. Moreover, when the NASs 5 receive the image obtainment requirement from the radiogram interpretation terminal 6, the NASs 5 confirm the access limiting information included in the accompanying information of the required image data. If the required image data is that from a user or a terminal to which the access from the radiogram interpretation terminal 6 is allowed, the NASs 5 retrieve the image data stored in the HDD to read it in response to the requirement, and transmit the read image data to the radiogram interpretation terminal 6. Incidentally, in the present embodiment, the description is given by exemplifying the case in which the HDD is applied as the storage medium for the writing of each of the NASs 5 of the image data instructed to be written by the write server 2 or the multiplex server 3, but the storage medium for writing the image data is not limited to the HDD, and the other storage media, for example a medium such as a DVD library, may be used.

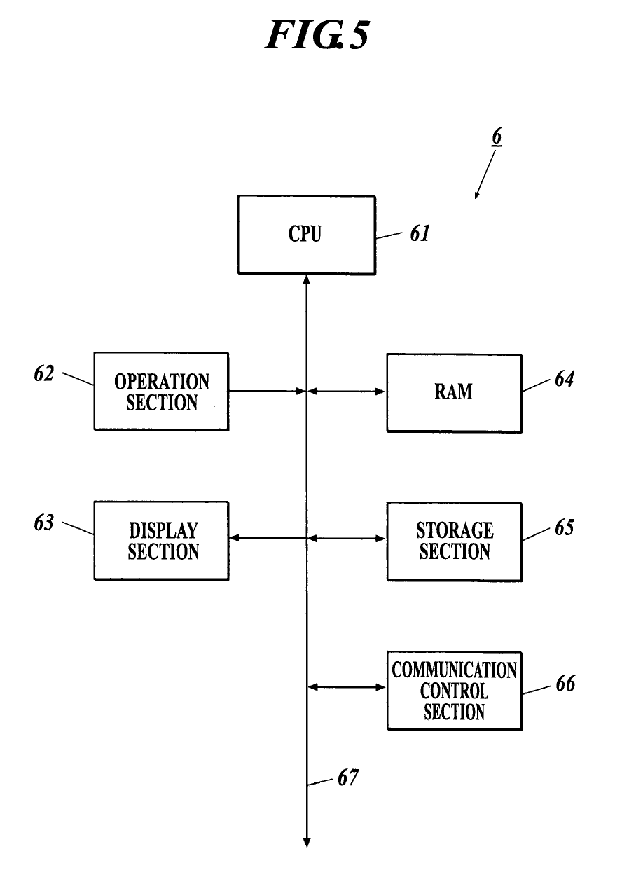

The radiogram interpretation terminal 6 is a terminal, such as a personal computer (PC), for a doctor to display a medical image for performing a radiogram interpretation diagnosis. As shown in FIG. 5, the radiogram interpretation terminal 6 is composed of a CPU 61, an operation section 62, a display section 63, a RAM 64, a storage section 65, a communication control section 66, and the like, and each section is connected to one another through a bus 67. The CPU 61 of the radiogram interpretation terminal 6 executes access destination confirming processing, which will be described later, by the software processing by the cooperation with the access destination confirming processing program stored in the storage section 65 in response to an instruction from the operation section 62, and obtains the image management information of the medical image the display of which has been instructed with the operation section 62 from the database 4 to display the obtained image management information in the display section 63. The cup 61 further obtains the image data from the NASs 5 specified with the operation section 62 to display the obtained image data.

Next, the operation of the present embodiment is displayed.

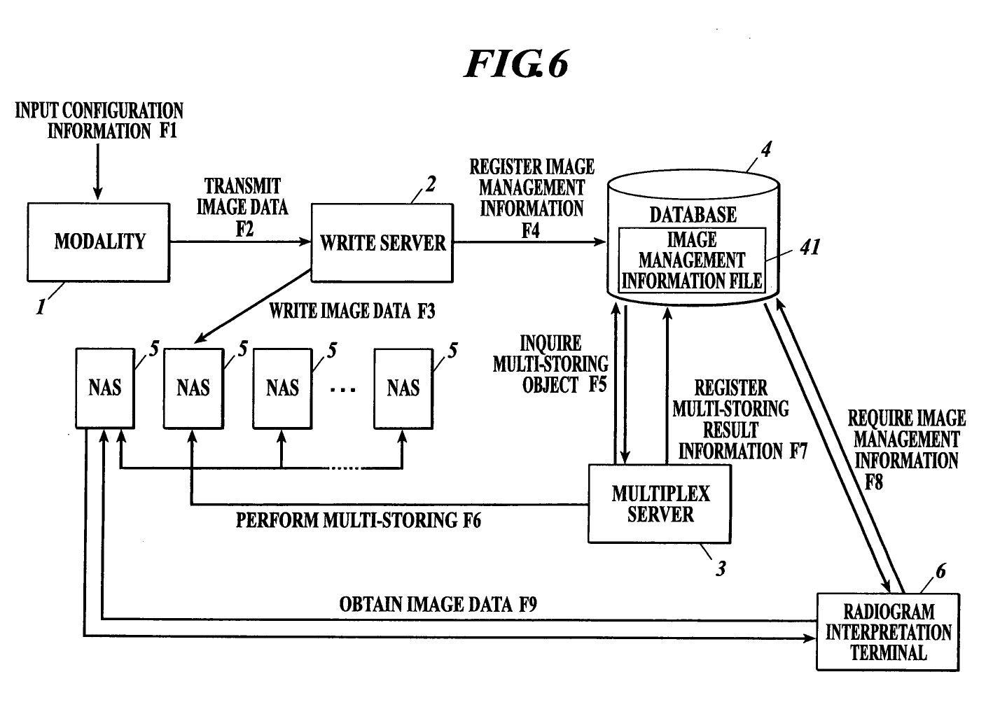

FIG. 6 shows the outline of the processing among each apparatus of the medical image management system 100.

First, configuration information (including storing destination information, multi-storing destination information, and multi-storing timing information) is input to be set in the modality 1 (F1). Next, the image data (including the accompanying information including the configuration information) of the medical image produced by the modality 1 is transmitted to the write server 2 (F2).

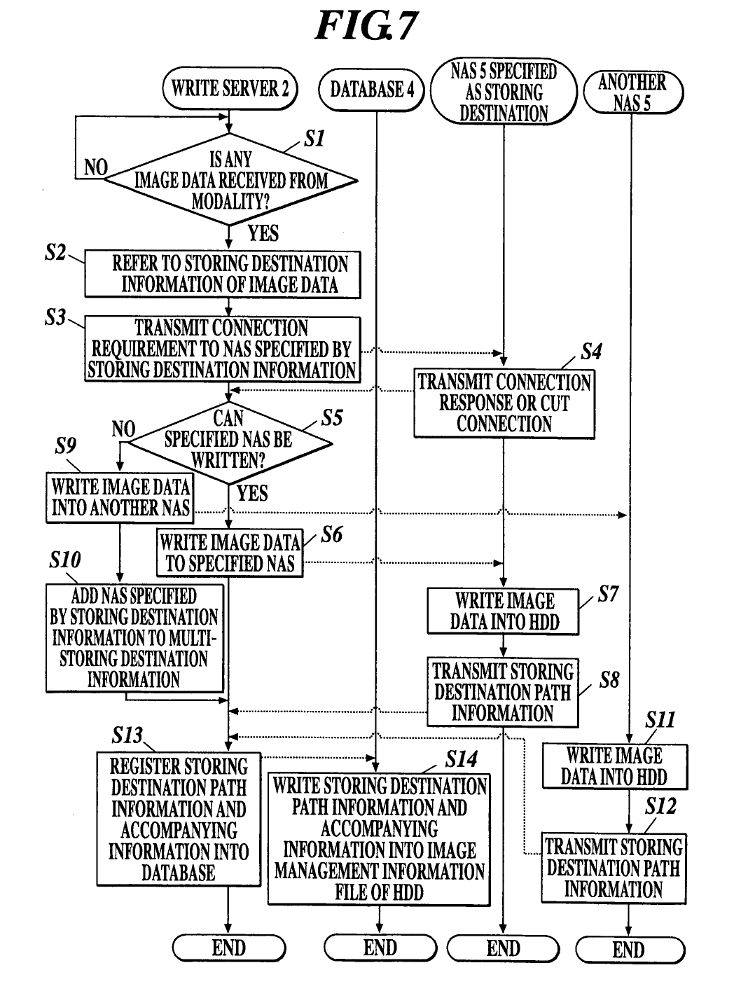

In the write server 2, image writing processing, which will be described later (see FIG. 7) is executed, and the image data is written in any of the NASs 5 specified by the storing destination information included in the accompanying information transmitted from the modality 1 (F3). Moreover, the path information (storing result information) of the actual storing destination of the image data and accompanying information are registered in the image management information file 41 of the database 4 (F4).

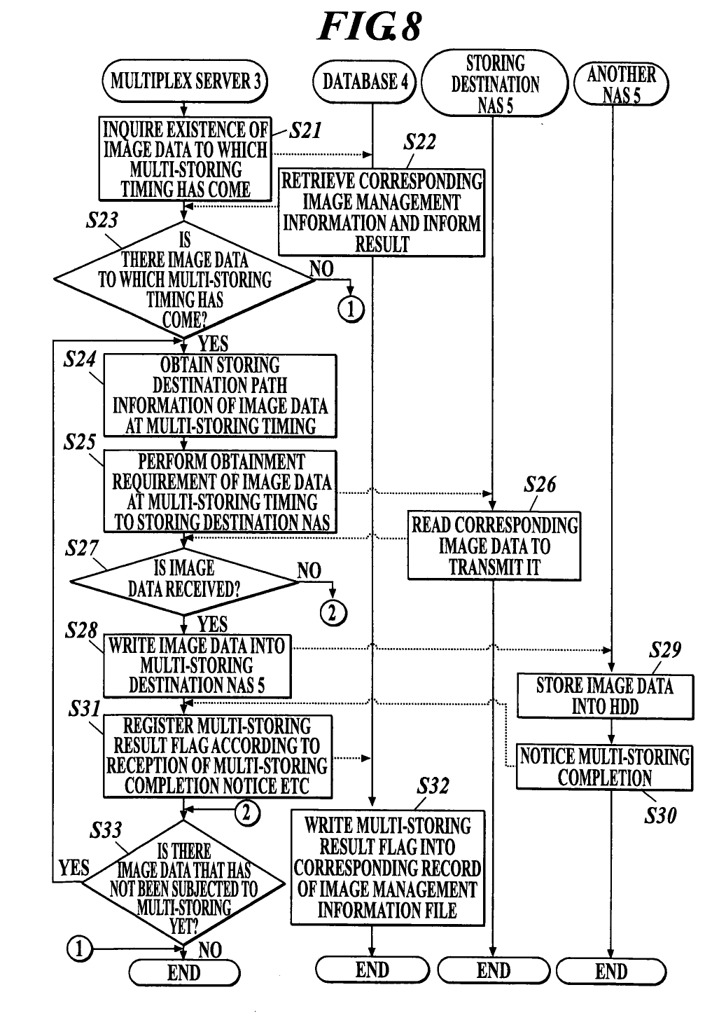

In the multiplex server 3, the multi-storing processing, which will be described later (see FIG. 8), is executed every predetermined time, and the inquiry of the image data of the multi-storing object the multi-storing timing of which has come is performed to the database 4 (F5) to perform multi-storing of the corresponding image data (F6). Then, the multi-storing result information is registered in the image management information file 41 of the database 4 (F7).

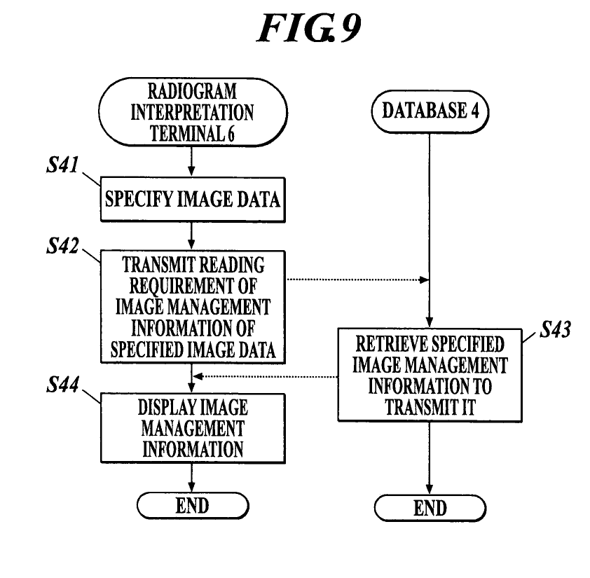

In the radiogram interpretation terminal 6, access destination confirming processing, which will be described later (see FIG. 9), is executed in accordance with the instruction from the operation section 62, and the image management information of the image data specified with the operation section 62 is obtained from the database 4 to be displayed in the display section 63 (F8). Furthermore, the access to the NAS 5 specified with the operation section 62 is performed, and the specified image data is obtained to be displayed in the display section 63 (F9).

FIG. 7 shows the image writing processing executed in the write server 2 and the image writing sequence executed in the write server 2, the database 4, and the NASs 5 in accordance with the image writing processing. The image writing processing is the processing realized by the software processing by the cooperation of the CPU 21 of the write server 2 and the image writing processing program, and the writing member is realized by the execution of the processing. In the following, the image writing sequence is described with reference to FIG. 7.

In the image writing processing, the communication control section 26 waits the reception of image data (including accompanying information) from the modality 1 (Step S1). When the communication control section 26 receives the image data (Step S1; YES), communication control section 26 refers to the storing destination information included in the accompanying information of the image data (Step S2), and transmits a connection requirement to the NAS 5 specified by the storing destination information (Step S3). If the NAS 5 specified by the storing destination information receives the connection requirement from the write server 2, the NAS 5 transmits a connection response to the write server 2 when the NAS 5 is in the state capable of communication connection, or cuts the connection with the write server 2 when the NAS 5 is in the state of incapable of communication connection (Step S4).

If the write server 2 judges that it is possible to write the image data into the NAS 5 specified by the storing destination information by receiving the connection response from the specified NAS 5 (Step S5; YES), the image data and a writing instruction of the image data are transmitted to the specified NAS 5, and the writing of the image data into the NAS 5 is preformed (Step S6). When the specified NAS 5 receives the image data, the received image data is written into the HDD (Step S7). Then, the storing destination path information of the written image data is transmitted to the write server 2 (Step S8).

If the write server 2 judges that it is impossible to write the image data into the NAS 5 specified by the storing destination information by the cutting of the communication with the specified NAS 5 (Step S5; NO), the connection requirements are transmitted to the NASs 5 other than the specified NAS 5, and then the image data and the writing instruction of the image data is transmitted to the NAS 5 that the connection thereof with the write server 2 is established to perform writing of the image to the other NAS 5 (Step S9). Moreover, the NAS 5 specified by the storing destination information is added to the multi-storing destination information of the image data, and the present time is added as the multi-storing timing information corresponding to the multi-storing destination information (Step S10). When the other NAS 5 receives the image data, the received image data is written into the HDD (Step S11). Then, the storing destination path information of the written image data is transmitted to the write server 2 (Step S12).

When the write server 2 receives the storing destination path information from the NAS 5 specified by the storing destination information or the other NAS 5, the storing destination path information and the accompanying information included in the image data is transmitted to the database 4, and the storing destination path information and the accompanying information are instructed to be registered into the image management information database (Step S13). When the database 4 receives the storing destination path information, the accompanying information, and the registration instruction from the write server 2, the database 4 adds a record to the image management information file 41, and registers the received storing destination path information and the accompanying information (Step S14). Then, the present processing ends.

FIG. 8 shows the multi-storing processing executed by the multiplex server 3, and the multi-storing processing sequences executed in the multiplex server 3, the database 4, and the NASs 5 in response to the multi-storing processing. The multi-storing processing is the processing realized by the software processing by the cooperation of the CPU 31 of the multiplex server 3 and the multi-storing processing program every predetermined time, and a multi-storing processing member is realized by the execution of the processing. In the following, the multi-storing processing sequences are described with reference to FIG. 8. Incidentally, the interval between the execution of the multi-storing processing and the next execution thereof is the one during which the monitoring function of the coming of multi-storing timing can be sufficiently brought out, for example, for about one or two minutes.

First, the communication control section 36 inquires of the database 4 about the existence of the image data to which multi-storing timing has come (Step S21). For example, the inquiry of the existence of the image data of the multi-storing object is performed by instructing the database 4 to retrieve the image management information that registers a time before the present time as multi-storing timing information and has a multi-storing result flag corresponding to the multi-storing timing information which flag indicates noncompletion. When the database 4 receives the inquiry of the existence of the image data to which multi-storing timing has come from the multiplex server 3, the corresponding image management information is retrieved in response to an instruction from the multiplex server 3, and transmits the retrieval result (for example, retrieved image management information) to the multiplex server 3 (Step S22).

When the multiplex server 3 receives the retrieval result from the database 4 with the communication control section 36, it is judged whether the image data to which multi-storing timing has come exists or not on the basis of the received retrieval result. For example, if the multiplex server 3 receives the information of the retrieval result indicating the nonexistence of the image data from the database 4, then the multiplex server 3 judges that no image data to which multi-storing timing has come exists. If the multiplex server 3 receives retrieved image management information from the database 4, then the multiplex server 3 judges that the image data to which multi-storing timing has come exists. If the multiplex server 3 judges that no image data to which multi-storing timing has come exists (Step S23; NO), then the present processing is completed.

On the other hand, if the multiplex server 3 judges that the image data to which multi-storing timing has come exists (Step S23; YES), the multiplex server 3 refers to one of the pieces of the image management information of the multi-storing objects received from the database 4, and obtains the storing destination path information of the image data which is the object of multi-storing timing (Step S24). Then, the multiplex server 3 performs the obtainment requirement of the image data stored in the storing destination path to the storing destination NAS 5 (Step S25). When the storing destination NAS 5 receives the requirement from the multiplex server 3, the image data stored in the specified storing destination path is read and transmitted to the multiplex server 3 (Step S26). When the multiplex server 3 receives the image data from the storing destination NAS 5 with the communication control section 36 (Step S27; YES), the processing moves to Step S28. If the multiplex server 3 has not normally received the image data from the storing destination NAS 5, for example, the connection with the storing destination NAS 5 has been cut (Step S27; NO), then the processing moves to Step S33.

At Step S28, the time before the present time is registered as multi-storing timing information in the image management information referred to at Step S24, and the multi-storing destination information having the multi-storing result flag indicating the noncompletion corresponding to the multi-storing timing information is obtained. The received image data is transmitted to the NAS 5 of the multi-storing destination, and the writing instruction of the image data is performed (Step S28).

Incidentally, if a plurality of pieces of correspond multi-storing destination information are obtained, then the image data is transmitted to all of the multi-storing destination NASs 5, and the writing instruction is performed.

When the multi-storing destination NAS 5 receives the image data from the multiplex server 3, the received image data is written into the HDD to be saved (Step S29). Then, the multi-storing completion notice of the image data is transmitted to the write server 2 (Step S30).

In the multiplex server 3, the image ID of the image management information referred to at Step S24, the information of the multi-storing destination NAS 5, and the multi-storing result information (the information indicating whether multi-storing has been completed or not) are transmitted to the database 4 in response to a reception of the multi-storing completion notice from the multi-storing destination NASs 5 (or the notice of the impossibility of access in the case where the access has been impossible, such as the case where the communication connection with the multi-storing destination NAS 5 has been cut), and the multi-storing result flag is instructed to be registered to the corresponding item of the image management information specified by the transmitted image ID (Step S31). When the database 4 receives the image ID, the multi-storing destination information, and the multi-storing result information from the write server 2, the database 4 writes the multi-storing result flag corresponding to the multi-storing result information into the corresponding item of the record specified by the transmitted image ID in the image management information file 41 (Step S32). In multiplex server 3, when the processing at Step S31 ends, it is judged whether the image data to which multi-storing timing has come but which has not performed any multi-storing yet or not on the basis of the existence of the image management information which has not been referred to yet at Step S24. If it is judged that the image data to which no multi-storing has been performed yet exists (Step S33; YES), then the processing returns to that at Step S24, and the multiplex server 3 refers to the next image management information to execute the processing subsequent to Step S24. If it is judged that multi-storing has been performed to all pieces of image data to which multi-storing timing has come (Step S33; NO), the present processing ends.

The multiplex server 3 periodically confirms the image management information registered in the database 4 by the execution of the multi-storing processing, and reads the image data to which multi-storing timing has come and multi-storing of which has not performed yet from the storing destination on the basis of the image management information to write the read image data into the specified multi-storing destination NAS 5. Then, the multiplex server 3 registers the result of multi-storing into the database 4. Consequently, it is possible to perform multi-storing of image data into the specified multi-storing destination NAS 5 at the specified multi-storing timing by setting the multi-storing destinations and the multi-storing timing information corresponding to each of the multi-storing destinations of the image data with the modality 1. That is, it becomes possible to perform multi-storing of image data into desired multi-storing destinations at the timing according to the kind of the image data, and the using of a facility level and the level of a person in charge. Moreover, since the multi-storing results are registered in the database 4, and the image data to which multi-storing timing has come but multi-storing of which has not performed yet is subjected to the multi-storing processing again, it becomes possible to perform multi-storing without exception at the time points when the NASs 5 become accessible even if multi-storing has not been performed at multi-storing timing owing to being out of order of the NASs 5 and a communication state.

FIG. 9 shows access destination confirming processing executed in the radiogram interpretation terminal 6 and access destination confirming processing sequences executed in the radiogram interpretation terminal 6 and the database 4 according to the access destination confirming processing. The access destination confirming processing is the processing realized by the software processing by the cooperation of the CPU 61 of the radiogram interpretation terminal 6 and the access destination confirming processing program. In the following, the access destination confirming processing sequences are described with reference to FIG. 9.

When the operation section 62 specifies the image data to be the object of the access destination confirmation (the image ID of the image data here) (Step S41), the specified image ID is transmitted to the database 4, and then a reading requirement of the image management information having the specified image ID is transmitted to the database 4 (Step S42). When the database 4 receives the reading requirement of the image management information from the radiogram interpretation terminal 6, the image management information file 41 is retrieved on the basis of the image ID transmitted from the radiogram interpretation terminal 6, and the retrieved image management information is transmitted to the radiogram interpretation terminal 6 (Step S43). When the radiogram interpretation terminal 6 receives the image management information from the database 4, the received image management information is displayed in the display section 63 (Step S44), and the present processing ends.

The image management information includes the storing destination path information and the multi-storing destination information of the image data, and the multi-storing timing and the multi-storing result of each multi-storing destination. Moreover, the image management information also includes the access-allowed users and the access-allowed terminals of a storing destination and each multi-storing destination. Consequently, a user can confirm which NAS 5 enables the obtainment of image data by accessing the NAS at the time of displaying the image data. Moreover, the user can confirm whether multi-storing processing has been performed surely, and the scheduled multi-storing time to each of the NASs 5.

Incidentally, the radiogram interpretation terminal 6 may judge accessible NASs 5 on the basis of the image management information received in the access destination confirming processing mentioned above, and may automatically perform the connection to the accessible NASs to obtain image data. The radiogram interpretation terminal 6 may thus display the medical image of the image data in the display section 63.

As described above, the medical image management system 100 is provided with a plurality of NASs 5 for storing the image data of a medical image and the modality 1, which sets configuration information on the image data of the medical image, the configuration information including storing destination information indicating the storing destination of the image data, the multi-storing destination information indicating the multi-storing destination of the image data, the multi-storing timing information to each multi-storing destination. The modality 1 accompanies the set configuration information with the image data to transmit it to the write server 2. The write server 2 registers the configuration information accompanying the image data input from the modality 1 in the image management information file 41 of the database 4, and performs the writing of the image data into at least one of the NASs 5 on the basis of the set storing destination information to register the storing result into the management information file 41 of the database 4. The multiplex server 3 performs an inquiry to the database 4 every predetermined time, and writes the image data the multi-storing timing of which has come into a specified multi-storing destination NAS 5, and registers the multi-storing result information into the image management information file 41. The radiogram interpretation terminal 6 requires the image management information of an object image data to the database 4 at the time of accessing the image data, and the database 4 supplies the image management information of the specified image data to the radiogram interpretation terminal 6 in response to a requirement from the radiogram interpretation terminal 6.

Consequently, it becomes possible to perform multi-storing of image data to desired multi-storing destinations at the timing according to the kind of the image data, and the using of the facility level and the level of the person in charge. That is, since it becomes possible to perform multi-storing of a medical image only to the necessary NASs 5 at as-needed timing, the loads of a communication network and a server can be reduced, and it becomes possible to suppress the waste consumption of the capacity of the NASs 5 owing to the waste performance of multi-storing of the conventional case of performing multi-storing equally. Moreover, since the multi-storing timing can be set according to the degree of importance of image data and multi-storing destinations, it becomes possible to perform preferentially multi-storing to the image data and the multi-storing destination each having a relatively high degree of importance.

Moreover, since configuration information, storing results, and multi-storing results have been registered in the database 4 in advance and a user can confirm them from the radiogram interpretation terminal 6, the disadvantage in which the user cannot know which NAS 5 the user should access in order to obtain desired image data at the time of displaying the image data is not caused. Furthermore, it becomes possible to confirm whether multi-storing processing has been surely performed or not by confirming the scheduled multi-storing time to each of the NASs 5.

Moreover, as to the image data to which multi-storing timing has come but multi-storing of which has not been performed yet, the multi-storing processing of the image data is performed after a predetermined time again. Consequently, even if multi-storing cannot be performed at the multi-storing timing owing to a trouble and a communication state, multi-storing can perform at the time point when the access to the NAS 5 becomes possible without exception.

Moreover, if produced image data cannot be stored in a storing destination NAS 5 because the NAS 5 is jammed or is output of order when the image data is initially written in to the NAS 5 to save the image data therein, the image data is stored in another NAS 5, and the storing result is registered in the database 4. Consequently, even if the storing destination NAS 5 is in a state incapable of being written, the storing of image data can be performed without causing no delay of the processing and no using problem of being unknown of the storing destination of image data.

Moreover, since the conditions, such as the access limiting information of the image data, of the processing of each image data besides multi-storing destinations and multi-storing timing can be set in advance, it becomes possible to limit or expand the processing of the image data stored in each of the NASs 5 individually.

Incidentally, the contents of the description of the embodiment described above are a suitable example of the medical image management system 100 according to the present invention, and the present invention is not limited above contents.

For example, although the write server 2 to perform image writing processing and the multiplex server 3 to perform multi-storing processing have been described to be separated ones in the embodiment described above, the same apparatus may have the function of executing the image writing processing and the multi-storing processing.

Moreover, although the setting of the configuration information is performed in the modality 1, the setting can also be performed in the write server 2.

In addition, as to the detailed configurations of the constituent portions and the detailed operations of the medical image management system 100 of the present embodiment, they can be suitably changed without departing from the spirit and scope of the present invention.

Incidentally, all of the disclosures including the specification, claims, drawings and abstract of Japanese Patent Application No. 2006-61064 filed on Mar. 7, 2006 are incorporated herein to the present application by reference.

### INDUSTRIAL APPLICABILITY

The present invention can be applied to the medical image management system storing and managing a medical image to supply the medical image to a radiogram interpretation terminal as the occasion demands in the field of medical treatment.

### DESCRIPTION OF SIGNS

100 medical image management system
1 modality
2 write server
3 multiplex server
4 database
41 image management information file
5 NAS
6 radiogram interpretation terminal
21, 31, 61 CPU
22, 32, 62 operation section
23, 33, 63 display section
24, 34, 64 RAM
25, 35, 65 storage section
26, 36, 66 communication control section
27, 37, 67 bus

1. A medical image management system to manage a medical image produced by an image producing member to radiograph a subject to produce the medical image, and to supply the medical image in response to a requirement from a radiogram interpretation terminal equipped with a display member, the system comprising:
a plurality of image storing members to store the produced medical image;
a setting member to set configuration information on the produced medical image, the configuration information including storing destination information specifying an image storing member to be a storing destination of the medical image, multi-storing destination information specifying an image storing member to be a multi-storing destination of the medical image, and multi-storing timing information indicating multi-storing timing of the medical image to the image storing member to be the multi-storing destination;
an image management information storing member to store image management information, the image management information being information for managing the medical image and including the configuration information set by the setting member;
a writing member to write the produced medical image into at least one of the plurality of image storing members on a basis of the storing destination information set on the medical image;
a multi-storing processing member to perform multi-storing of the medical image into the set image storing member at the set multi-storing timing on a basis of the multi-storing destination information and the multi-storing timing information, both set on the medical image; and
an image management information supplying member to read the image management information of the medical image from the image management information storing member in response to a requirement of the radiogram interpretation terminal and supplying the read image management information.

2. The medical image management system according to claim 1, wherein the multi-storing processing member registers multi-storing result information indicating whether multi-storing has been completed or not into the image management information storing member.

3. The medical image management system according to claim 1, wherein the writing member writes the medical image into another image storing member and registers storing result information into the image management information storing member when it is impossible to write the medical image into the image storing member corresponding to the storing destination information set on the medical image.

4. The medical image management system according to claim 3, wherein the writing member adds information about the image storing member corresponding to the storing destination information set on the medical image and predetermined multi-storing timing information to the multi-storing destination information set on the medical image when it is impossible to write the medical image into the image storing member corresponding to the storing destination information set on the medical image.

5. The medical image management system according to claim 1, wherein
the setting member is capable of setting access limiting information for limiting access to the medical image in the image storing member to be the storing destination or the multi-storing destination of the medical image;
the image management information storing member stores the image management information including the access limiting information for limiting the access to the medical image in the image storing member to be the storing destination or the multi-storing destination of the medical image; and
the image management information supplying member supplies the image management information including the access limiting information to the radiogram interpretation terminal.
